(19) United States
(12) Patent Application Publication
(10) Pub. No.: US 2009/0141612 A1
(43) Pub. Date: Jun. 4, 2009

(54) HOLOGRAM REPRODUCING APPARATUS AND HOLOGRAM REPRODUCING METHOD

(75) Inventor: Shinji Mitsuya, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 12/365,373

(22) Filed: Feb. 4, 2009

(30) Foreign Application Priority Data
Aug. 7, 2006 (JP) 2006-214374
Aug. 2, 2007 (JP) PCT/JP2007/065189

(51) Int. Cl. G11B 7/00

(52) U.S. Cl. 369/103; G9B/7

(57) ABSTRACT

Almost all regions of a liquid crystal element 24 is used as a reproduction light transmission region. Through the reproduction light transmission region, a large volume of reproduction light 25a, 26a, and 27a transmits, and the light is received on a light reception part 29. Then, reproduction initial setting for adjusting an incident position, an incident angle θ2, a wavelength, and the like of reproduction reference light 28 is performed. After the reproduction initial setting, the reproduction light transmission region is narrowed to transmit only certain hologram data through the reproduction light transmission region, the light is received on the light reception part 29, and hologram reproduction is performed. In the present invention, the reproduction initial setting can be easily and appropriately performed. Further, the succeeding hologram reproduction can be appropriately performed.

### CLAIM OF PRIORITY

This application claims benefit of the Japanese Patent Application No. 2006-214374 filed on Aug. 7, 2006, which is hereby incorporated by reference.

### BACKGROUND OF THE INVENTION

1. Field of the Invention

The present invention relates to a hologram reproducing apparatus and a hologram reproducing method for reproducing hologram data recorded on a recording medium by irradiating a reproduction reference light.

2. Description of the Related Art

As described in Japanese Unexamined Patent Application Publication No. 2006-58726, Japanese Unexamined Patent Application Publication No. 2005-331864, and Japanese Unexamined Patent Application Publication No. 2003-233293, in reproduction of hologram data, reproduction reference light is irradiated onto a recording medium that records hologram data. Then, in accordance to Bragg condition, the reproduction reference light is diffracted by interference fringes of the data, and reproduction light is emitted. The reproduction light is received by a light reception device such as a charge-coupled device (CCD), a complementary metal-oxide semiconductor (CMOS), or the like and contents of the hologram data contained in the reproduction light is read. In the invention described in Japanese Unexamined Patent Application Publication No. 2006-58726, a pinhole filter is provided between a recording medium and a light receiving part. In the patent document, the pinhole filter transmits only reproduction light of a certain hologram and blocks reproduction light of the other holograms. Accordingly, the plurality of holograms recorded on the recording medium can be read respectively (see, for example, the section of “Effects of the Invention” in Japanese Unexamined Patent Application Publication No. 2006-58726).

However, the invention described in Japanese Unexamined Patent Application Publication No. 2006-58726 has the following drawback. That is, it is difficult to appropriately perform reproduction initial setting for adjusting an incident angle, a wavelength, an incident position, and the like of reproduction reference light for reading the holograms recorded on the recording medium to the recording medium. Accordingly, it is sometimes difficult to appropriately perform hologram reproduction. The drawback is described with reference to FIG. 12.

As illustrated in FIG. 12, on a recording medium 1, a large volume of hologram data 2 is recorded. In order to increase recording density, generally, adjacent hologram data 2 is recorded such that the hologram data 2 overlaps with each other in some part (center to center distance of each hologram data is approximately several hundreds micron meters). In the description, in order to facilitate understanding the drawing, it is assumed that each hologram data 2 is separately recorded.

When an incident angle θ1 and a wavelength of reproduction reference light 3 emitted from a light source formed by a semiconductor laser or the like correspond to those of reference light at the time of recording, as illustrated in FIG. 12, Bragg diffraction occurs at each hologram data 2. Then, reproduction light 4 is emitted toward a reception part 6 such as a CMOS.

However, due to a factor such as environmental changes at reproduction, in some cases, the incident angle θ1 and the wavelength of the reproduction reference light 3 do not correspond to those of the reference light at the recording. In such a case, Bragg diffraction does not appropriately occur, and the reproduction light 4 may not be emitted at all or the intensity of the reproduction light 4 may be low. To solve the problem, it is necessary to appropriately adjust the incident angle θ1 and the wavelength of the reproduction reference light 3.

As illustrated in FIG. 12, in a case where a pinhole filter 5 having a pinhole 5a is provided between the recording medium 1 and the reception part 6, if a positional deviation of the pinhole filter 5 has occurred, the light reception part 6 cannot receive the reproduction light 4 at all. Accordingly, first, it is necessary to adjust the position of the pinhole filter 5.

However, if a positional deviation of the pinhole filter 5 occurs, and the reception part 6 cannot receive the reproduction light at all, there is no information to which direction the position of the pinhole filter 5 is to be moved. Further, even if the reproduction reference light 3 is irradiated, there is a possibility that reproduction light 4 is not emitted from the recording medium 1 at all. Thus, in addition to the necessity for moving the pinhole filter 5, it is necessary to change the incident angle θ1 and the wavelength of the reproduction reference light 3 at each movement point and check whether the reception part 6 can receive the light or not. Further, since the recording interval of the hologram data 2 is approximately several hundreds micron meters, it is necessary to adjust the position of the pinhole filter 5 at a high accuracy of approximately several hundreds micron meters. Consequently, once the positional deviation of the pinhole filter 5 occurs, it is extremely difficult to perform the initial setting and various adjustments at succeeding hologram reproduction.

### SUMMARY OF THE INVENTION

The present invention has been made to solve the drawback. The present invention provides a hologram reproducing apparatus and a hologram reproducing method that can easily and appropriately perform initial setting for adjusting an incident angle, a wavelength, and the like of reproduction reference light, and appropriately perform succeeding hologram reproduction.

According to an aspect of the present invention, a hologram reproducing apparatus includes an installation part for installing a recording medium storing a plurality of hologram data, a light emitting part for emitting reference light toward the recording medium a light reception part for receiving reproduction light emitted form the recording medium, and a liquid crystal element provided between the recording medium and the light reception part. The liquid crystal element can be changed to a first state for transmitting the reproduction light from the plurality of hologram data toward the light reception part or a second state for transmitting only the reproduction light of one hologram data toward the light reception part.

In the present invention, as described above, by providing the liquid crystal element that can change the size of the transmission region of the reproduction light, after the incident position, the angle, the wavelength, and the like of the reproduction light are appropriately adjusted, the hologram data can be reproduced. That is, in the first state that the reproduction light transmits through the wide region, the reproduction initial setting for appropriately adjusting the incident position, the angle, the wavelength, and the like of the reproduction light can be performed. Accordingly, as compared to the invention described in Japanese Unexamined Patent Application Publication No. 2006-58726, the reproduction initial setting can be more appropriately performed. In the second state that the transmission region of the reproduction light is changed to be narrower than in the first state, while the intensity of the reproduction light is checked on the light reception part, the position adjustment of the transmission region can be appropriately performed. Accordingly, in the present invention, as compared to the known apparatuses, it is possible to more appropriately perform the reproduction of the hologram data.

According to another aspect of the present invention, a hologram reproducing apparatus includes an installation part for installing a recording medium storing a plurality of hologram data, a light emitting part for emitting reference light toward the recording medium, a light reception part for receiving reproduction light emitted form the recording medium, and a filter for transmitting a part of the reproduction light. The filter can be changed to a first state for transmitting the reproduction light from the plurality of hologram data toward the reception part by moving the outside of a facing region between the recording medium and the reception part and a second state for transmitting the reproduction light from the hologram data less than that in the first state toward the reception part by moving to the facing region.

According to yet another aspect of the present invention, a hologram reproducing apparatus includes an installation part for installing a recording medium storing a plurality of hologram data, a light emitting part for emitting reference light toward the recording medium, a light reception part for receiving reproduction light emitted form the recording medium, and diaphragm means configured to transmit a part of reproduction light, the diaphragm means being provided between the recording medium and the light reception part. The diaphragm means is formed by a plurality of plate-like filter members having notched parts at some parts, and the diaphragm means can be changed to a first state for transmitting the reproduction light from the plurality of hologram data toward the light reception part by separating each filter member or a second state for transmitting the reproduction light from the hologram data less than that in the first state toward the reception part by moving the filter members so as to come in contact with each other.

According to yet another aspect of the present invention, a hologram reproducing method includes irradiating reference light toward a recording medium storing a plurality of hologram data, receiving reproduction light emitted from the recording medium by a reception part, and reproducing the hologram data. In the hologram reproducing method, diaphragm means is provided between the recording medium and the reception part, and after reproduction initial setting is performed by controlling the diaphragm means such that the diaphragm is to be in a first state for transmitting the reproduction light from the recording medium side toward the reception part through a wide region, the diaphragm means is moved to a second state for transmitting the reproduction light through a region narrower than that in the first state, and hologram reproduction is performed in the second state.

In the present invention, as described above, in the first state that the reproduction light transmits through the wide region, the reproduction initial setting for appropriately adjusting the incident position, the angle, the wavelength, and the like of the reproduction light can be performed. Accordingly, as compared to the invention described in Japanese Unexamined Patent Application Publication No. 2006-58726, the reproduction initial setting can be more appropriately and easily performed. In the second state that the transmission region of the reproduction light is changed to be narrower than in the first state, while the intensity of the reproduction light is checked on the light reception part, the position adjustment of the transmission region can be appropriately performed. Accordingly, in the present invention, as compared to the known apparatuses, it is possible to more appropriately perform the reproduction of the hologram data.

In the present invention, it is preferable to provide a liquid crystal element as the diaphragm means between the recording medium and the light reception part. Preferably, in the first state that the wide entire region of the liquid crystal element is used as the light transmission region the reproduction initial setting is performed. Then, preferably, in the second that only a part of the liquid crystal element is adjusted as the light transmission region, the hologram reproduction is performed. Further, in the second state, after the position of the light transmission region is finely adjusted, the hologram reproduction may be performed.

Further, in the present invention, a filter having a light transmission hole may be provided as the diaphragm means between the recording medium and the light reception part. A size of the light transmission hole is adjustably controlled. After the reproduction initial setting is performed in the first state with the light transmission hole maximally widened, the light transmission hole may be gradually narrowed, and in the second state with the light transmission hole narrowed to a certain size, the hologram reproduction may be performed.

Further, in the present invention, a filter having a light transmission hole, the filter is controlled such that the filter can move between a facing region between the recording medium and the light reception part, within the facing region, and the outside of the facing region may be provided. After the reproduction initial setting is performed in the first state the filter is moved to the outside of the facing region, the hologram reproduction may be performed in the second state the filter is moved to the facing region.

In the present invention, the initial setting for adjusting the incident angle, the wavelength, and the like of the reproduction reference light can be easily and appropriately performed, and the succeeding hologram reproduction can be appropriately performed.

### BRIEF DESCRIPTION OF THE DRAWINGS

FIG. 1 is a schematic view illustrating reproduction initial setting performed by a hologram reproducing apparatus according to a first embodiment of the present invention.

FIG. 2 is a schematic view illustrating reproduction of hologram data from a recording medium performed by the hologram reproducing apparatus after the reproduction initial setting illustrated in FIG. 1 is performed.

FIG. 3 is a plane view illustrating a liquid crystal element used in the hologram reproducing apparatus according to the first embodiment of the present invention at the time of the reproduction initial setting (the liquid crystal element illustrated in FIG. 1 is a partial cross sectional view of the liquid crystal element illustrated in FIG. 3 taken along the line I-I in a film thickness direction and viewed from the arrow direction).

FIG. 4 is a plane view illustrating a liquid crystal element used in the hologram reproducing apparatus according to the first embodiment of the present invention at the time of the hologram reproduction (the liquid crystal element illustrated in FIG. 2 is a partial cross sectional view of the liquid crystal element illustrated in FIG. 4 taken along the line II-II in a film thickness direction and viewed from the arrow direction).

FIG. 5 is a plane view illustrating the liquid crystal element at the time a position of a light transmission hole formed on the liquid crystal element is finely adjusted.

FIG. 6 is a plane view illustrating a filter used as adjustable diaphragm means according to a second embodiment of the present invention, and the plane view illustrating a first state (at the time of reproduction initial setting).

FIG. 7 is a plane view illustrating a filter used as adjustable diaphragm means according to the second embodiment of the present invention, and the plane view illustrating a second state (at the time of hologram reproduction).

FIG. 8 is a schematic view illustrating reproduction initial setting performed by a hologram reproducing apparatus according to a third embodiment of the present invention.

FIG. 9 is a schematic view illustrating reproduction of hologram data from a recording medium performed by the hologram reproducing apparatus after the reproduction initial setting illustrated in FIG. 8 is performed.

FIG. 10 is a plane view illustrating a filter used as adjustable diaphragm means according to a fourth embodiment of the present invention, and the plane view illustrating a first state (at the time of reproduction initial setting).

FIG. 11 is a plane view illustrating a filter used as adjustable diaphragm means according to the fourth embodiment of the present invention, and the plane view illustrating a second state (at the time of hologram reproduction).

FIG. 12 is a schematic view for explaining a drawback that occurs when a known hologram reproducing apparatus having a pinhole filter is used.

### DESCRIPTION OF THE PREFERRED EMBODIMENTS

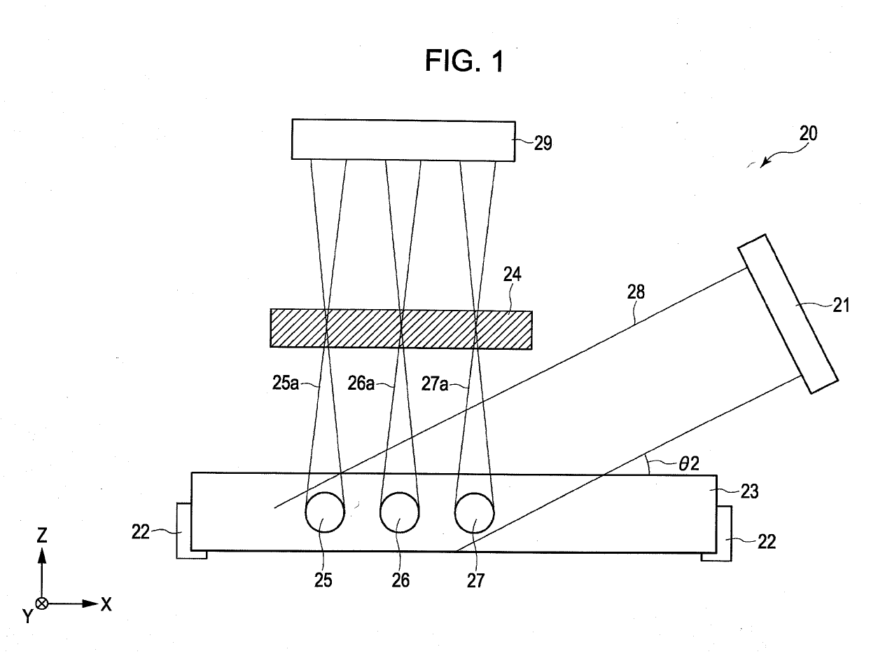

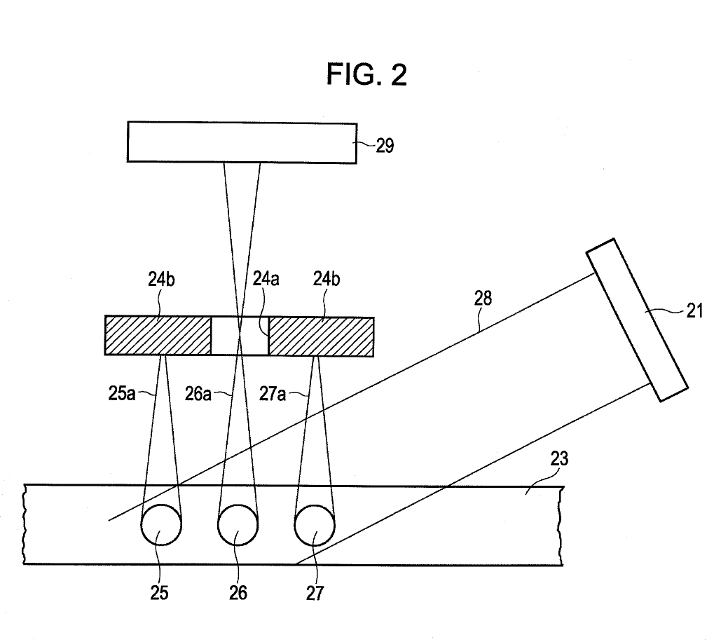

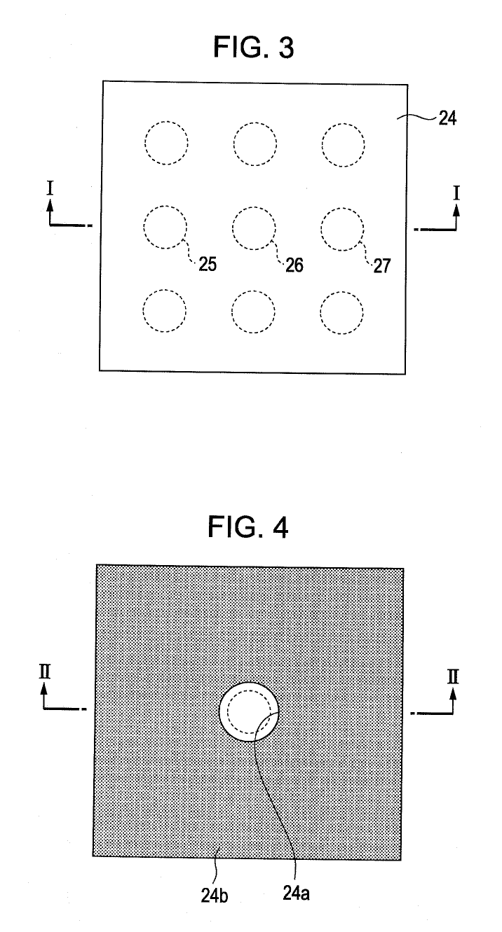

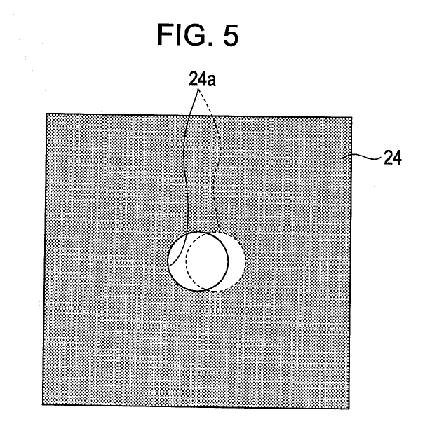

FIGS. 1 and 2 illustrate a first embodiment. FIG. 1 is a schematic view illustrating reproduction initial setting performed by a hologram reproducing apparatus according to the first embodiment of the present invention. FIG. 2 is a schematic view illustrating reproduction of hologram data from a recording medium performed by the hologram reproducing apparatus after the reproduction initial setting illustrated in FIG. 1 is performed. FIG. 3 is a plane view illustrating a liquid crystal element used in the hologram reproducing apparatus according to the first embodiment of the present invention at the time of the reproduction initial setting (the liquid crystal element illustrated in FIG. 1 is a partial cross sectional view of the liquid crystal element illustrated in FIG. 3 taken along the line I-I in a film thickness direction and viewed from the arrow direction). FIG. 4 is a plane view illustrating a liquid crystal element used in the hologram reproducing apparatus according to the first embodiment of the present invention at the time of the hologram reproduction (the liquid crystal element illustrated in FIG. 2 is a partial cross sectional view of the liquid crystal element illustrated in FIG. 4 taken along the line II-II in a film thickness direction and viewed from the arrow direction). FIG. 5 is a plane view illustrating the liquid crystal element at the time a position of a light transmission hole formed on the liquid crystal element is finely adjusted.

A hologram reproducing apparatus 20 illustrated in FIG. 1 includes, a light emitting part 21, for example, a vertical-cavity surface-emitting laser (VCSEL) array that has a plurality of VCSELs on the same substrate, an installation part 22 for installing a hologram recording medium 23, a light reception part 29 for receiving reproduction light 25a to 27a emitted from the hologram recording medium 23, the light reception part 29 is formed by a CCD or a CMOS, and a liquid crystal element 24 that functions as a diaphragm member positioned between the light reception part 29 and the hologram recording medium 23.

On the hologram recording medium 23, a large volume of hologram data 25, 26, and 27 is recorded by a hologram recording apparatus (not shown). The hologram data 25, 26, and 27 appears as interference fringes. On the same regions where each of the hologram data 25, 26, and 27 is recorded, a large volume of hologram data is recorded, for example, by angular multiplexing or wavelength multiplexing. The same region where the large volume of the hologram data is recorded is referred to as “book”. Each hologram data recorded on the book is referred to as “page”. The hologram data 25, 26, and 27 illustrated in FIG. 1 is recorded on different books respectively. The hologram data 25, 26, and 27 is recorded at an incident angle θ2 and a wavelength of the same reference light respectively. In FIG. 1, in order to simplify the drawing, the hologram data 25, 26, and 27 is recorded with spaces. In reality, the adjacent hologram data 25, 26, and 27 is recorded in a state the data is partly overlapped with each other. A center to center distance of each of the adjacent hologram data 25, 26, and 27 is approximately several hundreds micron meters.

FIG. 1 illustrates reproduction initial setting for adjusting an incident position, an incident angle θ2 and a wavelength of reproduction reference light 28.

As illustrated in FIG. 1, from the light emitting part 21 in the hologram reproducing apparatus 20, the reproduction reference light 28 is irradiated toward the hologram recording medium 23. Between the light emitting part 21 and the installation part 22, an lens array (not shown) is provided. The reproduction reference light 28 is irradiated onto the hologram recording medium 23 as parallel light. As illustrated in FIG. 1, the incident angle to the surface of the hologram recording medium 23 of the reproduction reference light 28 is illustrated as θ2.

In the reproduction initial setting illustrated in FIG. 1, the liquid crystal element 24 is set to the first state that almost all region is a reproduction light transmission region. The liquid crystal element 24 is formed such that a large number of transparent electrodes extending in a longitudinal direction (Y direction in the drawing) with a certain space in a lateral direction (X direction in the drawing) are opposite to a large number of transparent electrodes extending in the lateral direction (X direction in the drawing) with a certain space in the longitudinal direction (Y direction in the drawing) through a liquid crystal layer. Parts where the transparent electrodes intersect with each other in planar view are pixels. The size of a reproduction light transmission region 24a formed on the liquid crystal element 24 at succeeding hologram reproduction can be controlled finer as the number of the pixels is increased. Further, for example, by increasing a voltage value to be applied to each pixel, a relative luminance can be decreased.

FIGS. 1 and 3 illustrate states that voltage is not applied to each pixel in the liquid crystal element 24 and almost all regions of the liquid crystal element 24 are set as the reproduction light transmission region. Especially, FIG. 3 illustrates a state that all regions of the liquid crystal element 24 are transmission regions for the large volume of hologram data (illustrated by circular dotted lines) recorded on the hologram recording medium 23.

As illustrated in FIG. 1, when the reproduction reference light 28 is irradiated toward the hologram data 25, 26, and 27, if Bragg condition is satisfied, the reproduction reference light 28 is diffracted and emitted as reproduction light (diffracted light) 25a, 26a, and 27a from the hologram recording medium 23 toward the light reception part 29.

When light intensity of the reproduction light 25a, 26a, and 27a received by the light reception part 29 is low, or when the reproduction light 25a, 26a, and 27a has not received, the incident position, the incident angle θ2, the wavelength, and the like of the reproduction reference light 28 are adjusted such that the reproduction light 25a, 26a, and 27a can be appropriately received by the light reception part 29 (reproduction initial setting).

In the setting, the all regions of the liquid crystal element 24 are set as the reproduction light transmission region. Then, as illustrated in FIGS. 1 and 3, all of the reproduction light 25a, 26a, and 27a irradiated from the hologram recording medium 23 toward the light reception part 29 can transmit through the liquid crystal element 24 and can be appropriately received by the light reception part 29. In reality, between the installation part 22 and the light reception part 29, a lens array is provided. However, in the drawings, the lens array is omitted.

Now, a state (second state) that after the reproduction initial setting is completed, for example, in order to appropriately reproduce the hologram data 26, the reproduction light transmission region 24a for transmitting only the reproduction light 26a of the hologram data 26 is formed on the liquid crystal element 24 is described.

As illustrated in FIGS. 2 and 4, now, it is tried to receive only the reproduction light 26a emitted from the hologram data 26. Then, while a light reception state of reproduction light emitted toward the light reception part 29 is checked, a non-transmission region 24b that does not transmit light is formed by leaving a certain region (reproduction light transmission region 24a). In the non-transmission region 24b, voltage to be applied to the individual transparent electrodes is adjusted such that the pixels in the liquid crystal display in black. The reproduction light transmission region 24a is formed at a position and a size only one reproduction light 26a can transmit.

As illustrated in FIGS. 2 and 4, the reproduction light 25a and 27a is irradiated toward the non-transmission region 24b in the liquid crystal element 24, and not received by the light reception part 29. On the other hand, the reproduction light 26a emitted form the hologram data 26 transmits the reproduction light transmission region 24a on the liquid crystal element 24, and is received by the light reception part 29.

A feature of the embodiment is the hologram reproducing apparatus 20 that has the diaphragm means (in the structure illustrated in FIGS. 1 and 2, the liquid crystal element 24) that can change the first state for receiving reproduction light in the wide region illustrated in FIG. 1 and the second state for receiving reproduction light in the narrow region illustrated in FIG. 2, and the hologram reproducing method using the hologram reproducing apparatus 20.

As illustrated in FIG. 1, in the first state the reproduction light transmission region of the liquid crystal element 24 is widened, the reproduction light 25a, 26a, and 27a can be appropriately received on the light reception part 29. Accordingly, the reproduction initial setting can be appropriately and easily performed. After the reproduction initial setting, the reproduction light transmission region 24a and the non-transmission region 24b are formed on the liquid crystal element 24. In the formation, the position and size of the reproduction light transmission region 24a can be adjusted while the light reception state is checked on the light reception part 29. Accordingly, it is possible to appropriately and easily adjust to the state only the reproduction light 26a from the hologram data 26 can be received. In the apparatus, it is preferable to gradually narrow the size of the reproduction light transmission region 24a while the light reception state is checked on the light reception part 29.

In the liquid crystal element 24, by adjusting the voltage to be applied to the individual pixels, the position of the reproduction light transmission region 24a can be freely changed in the liquid crystal element 24. Accordingly, even if the position of the liquid crystal element 24 is fixed, by adjusting the position of the reproduction light transmission region 24a, the large volume of the hologram data opposite to the liquid crystal element 24 can be easily and appropriately reproduced. For example, as illustrated in FIG. 3, it is assumed that the plurality of pieces of hologram data 25, 26, and 27 and the like faces the liquid crystal element 24. In such a case, the center to center distance of each of the hologram data 25, 26, and 27 is approximately several hundreds micron meters. Accordingly, by moving the reproduction light transmission region 24a by approximately several hundreds micron meters, reproduction light from adjacent hologram data can be appropriately received.

Further, by using the liquid crystal element 24, for example, in a case where the reproduction light transmission region 24a is slightly deviated, as illustrated in FIG. 5, by adjusting the voltage value to be applied to the individual pixels, the position of the reproduction light transmission region 24a can be easily and finely adjusted (the solid line illustrates the position of the reproduction light transmission region 24a before the fine adjustment, and the dotted line illustrates the position of the reproduction light transmission region 24a after the fine adjustment). As described above, as the number of pixels is increased, the fine adjustment can be performed finer.

Further, after all of the hologram data is reproduced in the region of the hologram recording medium 23 opposite to the liquid crystal element 24, the liquid crystal element 24 is moved to the other hologram data region. In the state, the liquid crystal element 24 and the light reception part 29 are connected with each other, and the light reception part 29 moves together with the movement of the liquid crystal element 24. In the case the liquid crystal element 24 is moved to the other place, it is preferable to perform the reproduction initial setting illustrated in FIG. 1 again and the hologram reproduction illustrated in FIG. 2 is performed to appropriately perform the hologram reproduction. However whether to perform the reproduction initial setting every time the liquid crystal element 24 is moved is optional. In the embodiment, the reproduction initial setting is performed at least at the time of startup according to the method illustrated in FIG. 1. However, after the reproduction initial setting, the reproduction initial setting is optional. The liquid crystal element 24 may be moved separately from the light reception part 29.

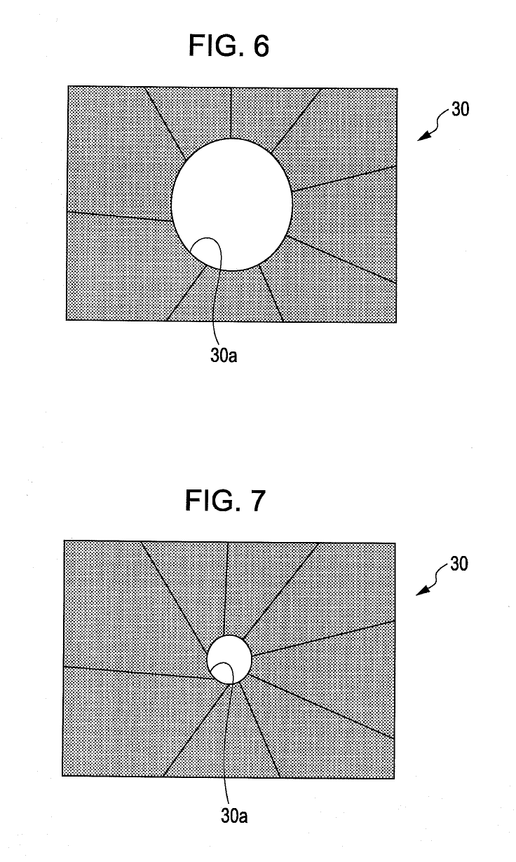

FIGS. 6 and 7 are plane views of a filter uses as adjustable diaphragm means according to a second embodiment of the present invention. FIG. 6 illustrates a state of the filter in a first state (at the time of reproduction initial setting). FIG. 7 illustrates a state of the filter in a second state (at the time of hologram reproduction).

As illustrated in FIGS. 6 and 7, a filter 30 has an iris diaphragm structure. At a center part of the iris diaphragm, a reproduction light transmission hole (pinhole) 30a is provided. The sizes of the diameter of the reproduction light transmission hole 30a can changed by the iris diaphragm structure.

The filter 30 is provided in place of the liquid crystal element 24 in the hologram reproducing apparatus 20 illustrated in FIGS. 1 and 2.

In FIG. 6, the diameter of the reproduction light transmission hole 30a is widened to a maximum diameter such that reproduction light from a large volume of hologram data transmits through the reproduction light transmission hole 30a and the light is received on the light reception part 29 (first state). Then, the reproduction initial setting is performed by adjusting an incident position, an incident angle θ2, a wavelength, and the like of the reproduction reference light 28.

Then, as illustrated in FIG. 7, the diameter of the reproduction light transmission hole 30a is gradually narrowed to a size only reproduction light from certain hologram data transmits through the reproduction light transmission hole 30a to block the other reproduction light. Thus, only the certain reproduction light is received on the light reception part 29, and hologram reproduction is performed.

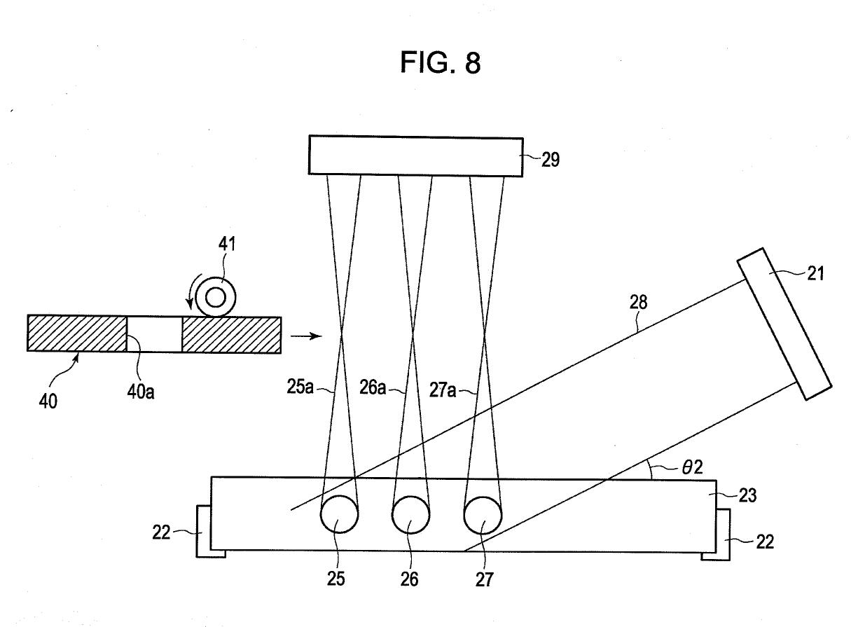

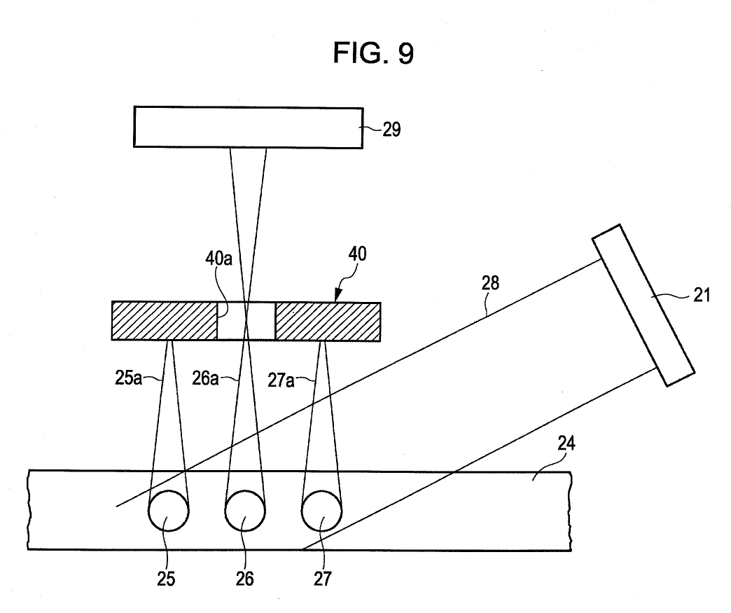

FIGS. 8 and 9 illustrate a third embodiment of the present invention. FIG. 8 is a schematic view illustrating reproduction initial setting performed by a hologram reproducing apparatus according to the third embodiment. FIG. 9 is a schematic view illustrating reproduction of hologram data from a recording medium performed by the hologram reproducing apparatus after the reproduction initial setting illustrated in FIG. 8 is performed. In the drawings, elements having the same reference numerals as those of the elements in FIGS. 1 and 2 are the same elements as those illustrated in FIGS. 1 and 2.

FIG. 8 illustrates a first state in the third embodiment. In the third embodiment, a filter 40 that has a reproduction light transmission hole (pinhole) 40a formed to have a size just one reproduction light can transmit is provided. Regions other than the reproduction light transmission hole 40a are non-transmission regions where light cannot transmit. The filter 40 is disposed such that the filter 40 can move between the light reception part 29 and the hologram recording medium 23. In the first state, the filter 40 is positioned in a region out of a facing region between the hologram recording medium 23 and the light reception part 29.

In the state (first state) illustrated in FIG. 8, the filter 40 is positioned in the region out of the facing region between the hologram recording medium 23 and the light reception part 29, all of the reproduction light 25a, 26a, and 27a from the hologram data 25, 26, and 27 is received on the light reception part 29. Accordingly, in the state illustrated in FIG. 8, the incident position, the incident angle θ2, the wavelength, and the like of the reproduction reference light 28 can be appropriately adjusted (reproduction initial setting).

After the reproduction initial setting, the filter 40 is moved to the facing region between the hologram recording medium 23 and the light reception part 29 (FIG. 9).

In the state (second state) illustrated in FIG. 9, only the reproduction light 26a from the hologram data 26 transmits through the reproduction light transmission hole 40a provided on the filter 40, and the other reproduction light 25a and 27a is blocked. The reproduction light 26a transmitted through the reproduction light transmission hole 40a is received on the light reception part 29, and hologram reproduction is performed.

For example, as illustrated in FIG. 8, at the position facing to an upper surface of the filter 40, a roller 41 that has an absorbing member for absorbing dust provided on the roller's surface may be provided. In the structure, by rotating the roller 41 with movement of the filter 40, dust or the like attached to the reproduction light transmission hole 40a can be removed by the roller 41.

In the structure the filter 40 having the reproduction light transmission hole 40a is moved to change from the first state illustrated in FIG. 8 to the second state illustrated in FIG. 9, during the movement from the first state to the second sate, a blank period that the reproduction light 26a from the hologram data 26 to be received is blocked is made. If there is the blank period, the positional adjustment of the reproduction light transmission hole 40a tends to be difficult as compared to the embodiments illustrated in FIGS. 1 to 7 in which the reproduction light 26a is always received.

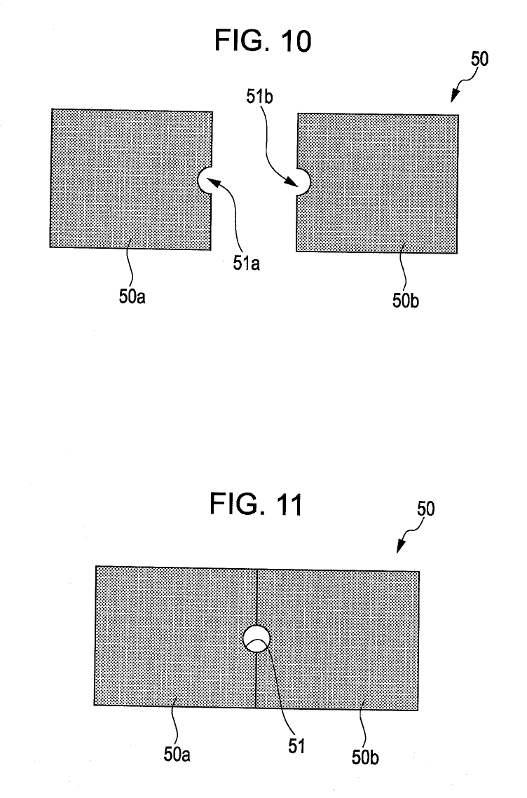

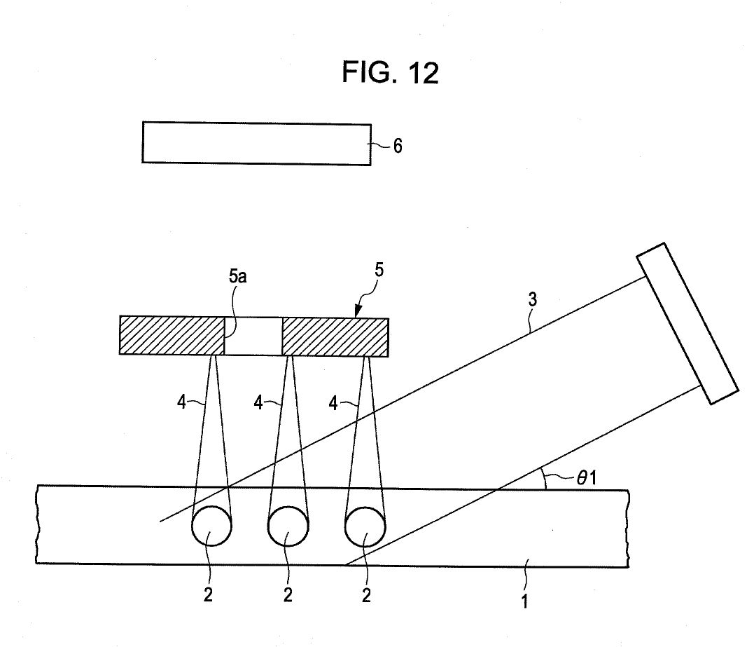

To solve the problem, for example, as illustrated in FIG. 10, a filter 50 that is divided into a plurality of pieces (in FIG. 10, two pieces of a first filter 50a and a second filter 50b) may be used. In the filter 50, at the same positions of facing parts in the first filter 50a and the second filter 50b, notched parts 51a and 51b are formed respectively. FIG. 10 illustrates a first state (at the time of initial setting). In the first state, the first filter 50a and the second filter 50b are separated from each other. By the structure, between the first filter 50a and the second filter 50b, reproduction light from a large volume of hologram data recorded on the hologram recording medium 23 transmits and the light is received on the light reception part 29. Thus, reproduction initial setting is performed.

After the reproduction initial setting, as illustrated in FIG. 11, the first filter 50a and the second filter 50b are moved until the filters come in contact with each other. By the movement, a reproduction light transmission hole 51 is formed with the notched parts 51a and 51b. Through the reproduction light transmission hole 51, only reproduction light of a certain hologram data transmits, and the reproduction light is received by the light reception part 29. Thus, hologram reproduction is performed (second state).

The first filter 50a and the second filter 50b may be shifted in a height direction and positioned. By the arrangement, in the state illustrated in FIG. 11, by positioning the first filter 50a and the second filter 50b such that the filters partially overlap with each other in the vertical direction, the size of the reproduction light transmission hole 51 can be changed.

In the embodiment illustrated in FIGS. 10 and 11, the formation of the blank period that the reproduction light 26a from the hologram data 26 to be received is blocked is prevented. Accordingly, in the second state illustrated in FIG. 11, it is possible to perform the positional adjustment of the reproduction light transmission hole 51 at high accuracy.

In the structures of the filters 30, 40, and 50 illustrated in FIGS. 6 to 11, the filters 30, 40, and 50 and the light reception part 29 may be connected with each other respectively, and the light reception part 29 may be moved together with movement of the filers 30, 40, and 50 respectively. Further, the filters 30, 40, and 50 may move separately from the light reception part 29 respectively.

The reproduction light 27 may be, as described in the embodiments, condensed once on the way to the light reception part, or may be parallel light or the like.

What is claimed is:

1. A hologram reproducing apparatus comprising:
an installation part for installing a recording medium storing a plurality of hologram data;
a light emitting part for emitting reference light toward the recording medium;
a light reception part for receiving reproduction light emitted form the recording medium; and
a liquid crystal element provided between the recording medium and the light reception part,
wherein the liquid crystal element can be changed to a first state for transmitting the reproduction light from the plurality of hologram data toward the light reception part or a second state for transmitting only the reproduction light of one hologram data toward the light reception part.

2. A hologram reproducing apparatus comprising:
an installation part for installing a recording medium storing a plurality of hologram data;
a light emitting part for emitting reference light toward the recording medium;
a light reception part for receiving reproduction light emitted form the recording medium; and
a filter for transmitting a part of the reproduction light,
wherein, the filter can be changed to a first state for transmitting the reproduction light from the plurality of hologram data toward the reception part by moving the outside of a facing region between the recording medium and the reception part and a second state for transmitting the reproduction light from the hologram data less than that in the first state toward the reception part by moving to the facing region.

3. A hologram reproducing apparatus comprising:
an installation part for installing a recording medium storing a plurality of hologram data;
a light emitting part for emitting reference light toward the recording medium;
a light reception part for receiving reproduction light emitted form the recording medium; and
diaphragm means configured to transmit a part of reproduction light, the diaphragm means being provided between the recording medium and the light reception part,
wherein the diaphragm means is formed by a plurality of plate-like filter members having notched parts at some parts, and the diaphragm means can be changed to a first state for transmitting the reproduction light from the plurality of hologram data toward the light reception part by separating each filter member or a second state for transmitting the reproduction light from the hologram data less than that in the first state toward the reception part by moving the filter members so as to come in contact with each other.

4. A hologram reproducing method comprising:
irradiating reference light toward a recording medium storing a plurality of hologram data;
receiving reproduction light emitted from the recording medium by a reception part; and
reproducing the hologram data,
wherein, diaphragm means is provided between the recording medium and the reception part, and
after reproduction initial setting is performed by controlling the diaphragm means such that the diaphragm is to be in a first state for transmitting the reproduction light from the recording medium side toward the reception part through a wide region, the diaphragm means is moved to a second state for transmitting the reproduction light through a region narrower than that in the first state, and hologram reproduction is performed in the second state.

5. The hologram reproducing method according to claim 4, wherein a liquid crystal element is provided as the diaphragm means, and a light transmission region on the liquid crystal element is controlled such that the first state and the second state are set.

6. The hologram reproducing method according to claim 5, wherein all regions of the liquid crystal element is the light transmission region in the first state.

7. The hologram reproducing method according to claim 6, wherein the hologram reproduction is performed in the second state and after the position of the light transmission region is finely adjusted.

8. The hologram reproducing method according to claim 4, wherein a filter having a light transmission hole is provided as the diaphragm means,
a size of the light transmission hole is adjustably controlled,
after the reproduction initial setting is performed in the first state with the light transmission hole maximally widened, the light transmission hole is gradually narrowed, and
in the second state with the light transmission hole narrowed to a certain size, the hologram reproduction is performed.

9. The hologram reproducing method according to claim 4, wherein the diaphragm means is a filter having a light transmission hole, and
after the reproduction initial setting is performed in the first state the filter is moved to the outside of the facing region between the recording medium and the reception part, the hologram reproduction is performed in the second state the filter is moved to the facing region.
